(19) United States
(12) Patent Application Publication
(10) Pub. No.: US 2026/0088714 A1
(43) Pub. Date: Mar. 26, 2026

(54) SWITCHED CAPACITOR CONVERTER ONLINE MODE TRANSITION

(71) Applicant: Apple Inc., Cupertino, CA (US)

(72) Inventors: Guangqi Zhu, Santa Clara, CA (US); Jukka-pekka J. Sjoeroos, Cupertino, CA (US); Stephen C. Terry, San Jose, CA (US)

(21) Appl. No.: 19/052,664

(22) Filed: Feb. 13, 2025

Related U.S. Application Data
(60) Provisional application No. 63/699,406, filed on Sep. 26, 2024.

(51) Int. Cl. H02M 3/07

(52) U.S. Cl. CPC H02M 3/07

(57) ABSTRACT

A power supply system can include a regulated converter that receives an input voltage and produces a regulated output voltage; a switched capacitor converter comprising one or more flying capacitors and a plurality of associated switching devices that receives the regulated output voltage of the regulated converter and multiplies it by a selectable conversion ratio; and control circuitry that operates the regulated converter and the switched capacitor converter to change the selectable conversion ratio while limiting inrush current flowing between the one or more flying capacitors of the switched capacitor converter and an output capacitor of the regulated converter.

### CROSS-REFERENCE TO RELATED APPLICATIONS

This application claims priority to U.S. Provisional Application No. 63/699,406, filed Sep. 26, 2024, which is incorporated by reference herein in its entirety.

### BACKGROUND

Switched capacitor converters can include one or more switched or “flying” capacitors and associated switching devices to selectively connect the flying capacitors in different configurations between the converter input and the converter output. In multi-stage embodiments, with multiple flying capacitor stages, selectively enabling or disabling stages can allow for different conversion ratios, i.e., the different ratios between the input voltage and the output voltage of the switched capacitor converter. In some cases, switching from one conversion ratio to another can result in undesirable inrush currents in the converter.

### SUMMARY

Thus, it may be desirable to provide improved switched capacitor converters that can mitigate inrush currents associated with transitions between operating modes.

A power supply system can include a regulated converter that receives an input voltage and produces a regulated output voltage; a switched capacitor converter comprising one or more flying capacitors and a plurality of associated switching devices that receives the regulated output voltage of the regulated converter and multiplies it by a selectable conversion ratio; and control circuitry that operates the regulated converter and the switched capacitor converter to change the selectable conversion ratio while limiting inrush current flowing between the one or more flying capacitors of the switched capacitor converter and an output capacitor of the regulated converter.

The regulated converter can include a 3-level buck converter. The regulated converter can include two 3-level buck converters operated in an interleaved fashion. The switched capacitor converter can include two switched capacitor stages and is capable of operating with a 3:1 conversion ratio, a 2:1 conversion ratio, and a 1:1 conversion ratio. The control circuitry can operate the switched capacitor converter according to first switching logic to achieve the 3:1 conversion ratio, according to second switching logic to achieve the 2:1 conversion ratio, and according to third switching logic to achieve the 1:1 conversion ratio. The switched capacitor converter can include two 3-level buck converters operated in an interleaved fashion.

The control circuitry can operate the regulated converter and the switched capacitor converter to change the selectable conversion ratio from a first conversion ratio to a second conversion ratio higher than the first conversion ratio while limiting inrush current flowing between the one or more flying capacitors of the switched capacitor converter and an output capacitor of the regulated converter by temporarily disabling one or more of the plurality of switches of the flying capacitor converter to block an inrush current path during a transition time. The transition time during which one or more of the plurality of switches of the flying capacitor converter are disabled can begin when a conversion ratio change request is received and can end after the regulated voltage of the regulated converter increases to a new voltage corresponding to a new conversion ratio and body diodes of the temporarily disabled switching devices begin conducting current. The transition time during which one or more of the plurality of switches of the flying capacitor converter are disabled can end after an output current of the regulated converter increases to a threshold value.

The control circuitry can provide a duty cycle feed forward term associated with the regulated converter to reduce the transition time.

The control circuitry can operate the regulated converter and the switched capacitor converter to change the selectable conversion ratio from a first conversion ratio to a second conversion ratio lower than the first conversion ratio while limiting inrush current flowing between the one or more flying capacitors of the switched capacitor converter and an output capacitor of the regulated converter by temporarily disabling one or more of the plurality of switches of the flying capacitor converter to block an inrush current path during a transition time. The transition time during which a first group of one or more switches is disabled can begin when a conversion ratio change request is received and can end after the regulated voltage of the regulated converter decreases to a voltage below a new voltage corresponding to a new conversion ratio as a result of negative current flowing through an inductor of the regulated converter. The transition time during which a second group of one or more switches is disabled can begin when the conversion ratio change request is received and can end after the regulated voltage of the regulated converter increases to a new voltage corresponding to the new conversion ratio. The transition time during which the second group of one or more switches is disabled can end after an output current of the regulated converter increases to a threshold value.

The control circuitry can operate the regulated converter and the switched capacitor converter to change the selectable conversion ratio from a first conversion ratio to a second conversion ratio while limiting inrush current flowing between the one or more flying capacitors of the switched capacitor converter and an output capacitor of the regulated converter by disabling the regulated converter; initiating a power off sequence of the switched capacitor converter; disabling the switched capacitor converter; re-enabling the regulated converter; and re-enabling the switched capacitor converter with the second conversion ratio.

A method of operating a power supply system comprising a regulated converter that receives an input voltage and produces a regulated output voltage and a switched capacitor converter including one or more flying capacitors and a plurality of associated switching devices that receives the regulated output voltage of the regulated converter and multiplies it by a selectable conversion ratio can be performed by control circuitry of the power supply system and can include changing the selectable conversion ratio; and limiting inrush current flowing between the one or more flying capacitors of the switched capacitor converter and an output capacitor of the regulated converter.

Changing the selectable conversion ratio can include changing the selectable conversion ratio from a first conversion ratio to a second conversion ratio higher than the first conversion ratio. Limiting inrush current flowing between the one or more flying capacitors of the switched capacitor converter and an output capacitor of the regulated converter can further include temporarily disabling one or more of the plurality of switches of the flying capacitor converter to block an inrush current path during a transition time. The transition time during which one or more of the plurality of switches of the flying capacitor converter are disabled can begin when a conversion ratio change request is received and can end after the regulated voltage of the regulated converter increases to a new voltage corresponding to a new conversion ratio and body diodes of the temporarily disabled switching devices begin conducting current. The transition time during which one or more of the plurality of switches of the flying capacitor converter are disabled can end after an output current of the regulated converter increases to a threshold value.

The method can further include providing a duty cycle feed forward term associated with the regulated converter to reduce the transition time.

Changing the selectable conversion ratio can include changing the selectable conversion ratio from a first conversion ratio to a second conversion ratio lower than the first conversion ratio. Limiting inrush current flowing between the one or more flying capacitors of the switched capacitor converter and an output capacitor of the regulated converter can include temporarily disabling one or more of the plurality of switches of the flying capacitor converter to block an inrush current path during a transition time. The transition time during which a first group of one or more switches is disabled can begin when a conversion ratio change request is received and can end after the regulated voltage of the regulated converter decreases to a voltage below a new voltage corresponding to a new conversion ratio as a result of negative current flowing through an inductor of the regulated converter. The transition time during which a second group of one or more switches is disabled can begin when the conversion ratio change request is received and can end after the regulated voltage of the regulated converter increases to a new voltage corresponding to the new conversion ratio. The transition time during which the second group of one or more switches is disabled can end after an output current of the regulated converter increases to a threshold value.

Changing the selectable conversion ratio can include changing the selectable conversion ratio from a first conversion ratio to a second conversion ratio. Limiting inrush current flowing between the one or more flying capacitors of the switched capacitor converter and an output capacitor of the regulated converter can further include disabling the regulated converter; initiating a power off sequence of the switched capacitor converter; disabling the switched capacitor converter; re-enabling the regulated converter; and re-enabling the switched capacitor converter with the second conversion ratio.

### BRIEF DESCRIPTION OF THE DRAWINGS

FIG. 1A illustrates a simplified block diagram of a power converter including a regulated converter cascaded with a switched capacitor converter.

FIG. 1B illustrates a simplified block diagram of an example power converter as in FIG. 1A in which the regulated converter is a three-level buck converter.

FIG. 1C illustrates a simplified schematic of the power stage of a power converter as in FIG. 1B.

FIG. 2A illustrates a schematic of a switched capacitor converter stage operating in a 3:1 conversion mode and associated switching logic.

FIG. 2B illustrates a schematic of a switched capacitor converter stage operating in a 2:1 conversion mode and associated switching logic.

FIG. 2C illustrates a schematic of a switched capacitor converter stage operating in a 1:1 conversion mode and associated switching logic.

FIG. 3 illustrates a timing diagram of a switched capacitor converter corresponding to a 2:1 to 3:1 mode transition and a depiction of inrush current causes for such a transition.

FIG. 4 illustrates a timing diagram of a switching transition to mitigate inrush current associated with a 2:1 to 3:1 mode transition of a switched capacitor converter and an associated control loop.

FIG. 5 illustrates a timing diagram of a first switching transition to mitigate inrush current associated with a 3:1 to 2:1 mode transition of a switched capacitor converter.

FIG. 6 illustrates a flow chart of a second switching transition to mitigate inrush current associated with a 3:1 to 2:1 mode transition of a switched capacitor converter.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

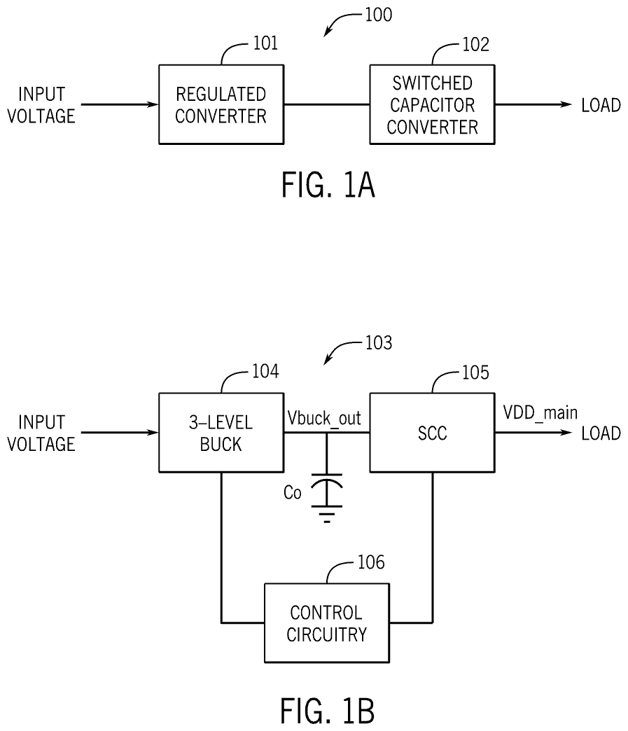

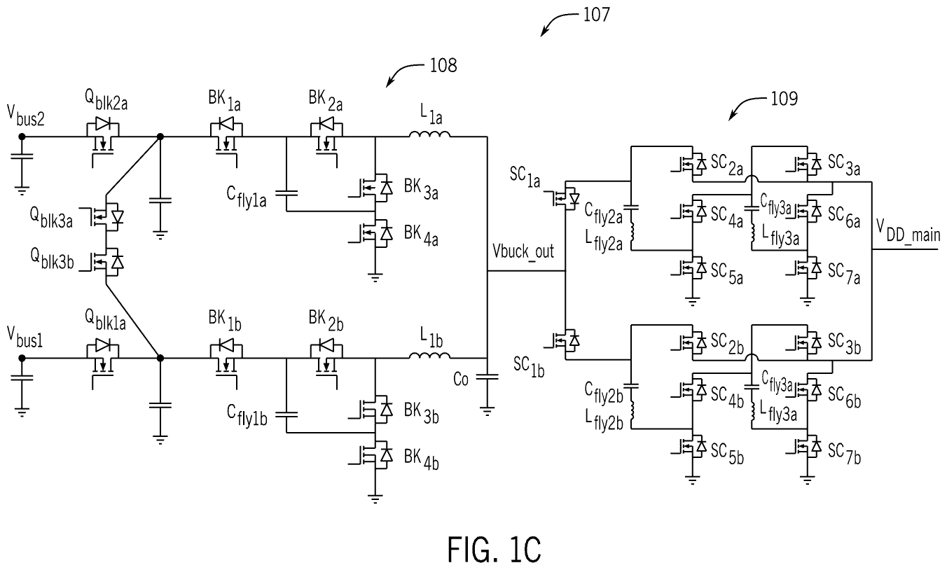

FIG. 1A illustrates a simplified block diagram of a power converter 100 including a regulated converter 101 cascaded with a switched capacitor converter 102. Regulated converter 101 can receive an input voltage and produce a regulated output voltage that can be provided as an input to switched capacitor converter 102. Switched capacitor converter 102 can then operate as described in greater detail below to produce an output voltage for a connected load that is an integer multiple (or integer fraction) of the regulated output voltage of regulated converter 101. In some embodiments, the load might be a battery charger circuit for charging a battery of a portable electronic device, although any of a variety of loads could be applied to such a circuit.

FIG. 1B illustrates a simplified block diagram of an example power converter 103 as in FIG. 1A in which the regulated converter is a three-level buck converter 104. Although the regulated converter in this example is a 3-level buck converter, other converter topologies could also be used, such as buck converters, buck-boost converters, boost converters, etc. The regulated output voltage in this example is identified as V_{buck_out}—corresponding to the use of 3-level buck converter. Additionally, the bus connecting the regulated output voltage to the input of switched capacitor converter 105 is illustrated as being supported by a capacitor Co, which may be thought of as the output capacitor of 3-level buck converter 104. This capacitor may be implemented as a single capacitor, multiple capacitors in parallel, etc. but will be discussed herein as a single capacitor. Additionally, the output voltage of switched capacitor converter 105, which is supplied to the load, is identified as V_{DD_main} for case of identification in the discussion that follows.

FIG. 1B also depicts control circuitry 106 that controls the switching devices of 3-level buck converter 104 and switched capacitor 105 (which are described in greater detail below) to produce the desired outputs of the respective converters. To that end, control circuitry may also monitor parameters such as the output voltages, output currents, input voltages, input currents, etc. of the respective converters and may implement control loops or logic to cause the switching devices of the converters to switch as required to provide the desired outputs. This control circuitry can be implemented using any suitable combination of analog circuitry (such as error amplifiers and the like), digital circuitry (such as logic gates, flip flops, and the like), and/or programmable circuitry (such as microcontrollers and associated firmware or the like). In some embodiments, control circuitry 106 may also provide functionality such as overvoltage protection, overcurrent protection, undervoltage protection, overtemperature protection, etc. To that end it may monitor other parameters, such as temperatures and can include logic or circuitry to provide the required protection functions.

FIG. 1C illustrates a simplified schematic of the power stage of a power converter 107 as in FIG. 1B. Control circuitry 106 has been omitted for brevity. Power converter 107 includes a 3-level buck converter 108 and a two-stage switched capacitor converter 109. The illustrated examples are just one possible implementation, and other circuit configurations could be provided if desired. Three-level buck converter 108 is implemented as having two symmetric trains, an upper train that receives an input voltage Vbus2 and a lower train that receives an input voltage Vbus1. These two trains can be operated in parallel or an interleaved fashion, meaning that one is operational while the other is idle and vice-versa. This can be useful, for example, if Vbus1 and Vbus2 are connected to respective terminals of an DC source, such as a wireless power receiving coil. Thus, whichever of Vbus1 or Vbus2 is active relative to the other can drive its respective 3-level buck converter train, while the other remains idle. Switches Qblk1a, Qblk2a, Qblk3a, and Qblk3b can thus be operated by the control circuitry to provide the desired parallel or interleaved operation. These switches (and other switching devices described herein) are illustrated as metal oxide semiconductor field effect transistors (MOSFETs), although other switching device types could be used if desired in a given application. Such switching devices can be implemented using any suitable semiconductor technology, such as silicon (Si), silicon carbide (SiC), gallium nitride (GaN), etc.

Each train of 3-level buck converter 108 also includes a 3-level buck converter. The upper train 3-level buck converter includes a flying capacitor stage made up of high side switches BK1a and BK2a, low side switches BK3a and BK4a, and a flying capacitor Cfly1a connected between the switch node (junction point) of the high side switches and the switch node (junction point) of the low side switches. The upper train 3-level buck converter also includes a buck inductor L1a connected between the switch node of the high side switches and the low side switches (i.e., the junction of switch BK2a and BK3a) and the output of the 3-level buck converter, which is coupled to output capacitor Co and where the V_{buck_out} voltage discussed above appears. Similarly, the lower train 3-level buck converter includes a flying capacitor stage made up of high side switches BK1b and BK2b, low side switches BK3b and BK4b, and a flying capacitor Cfly1b connected between the switch node (junction point) of the high side switches and the switch node (junction point) of the low side switches. The lower train 3-level buck converter also includes a buck inductor L1b connected between the switch node of the high side switches and the low side switches (i.e., the junction of switch BK2b and BK3b) and the output of the 3-level buck converter, which is coupled to output capacitor Co and where the regulated output voltage V_{buck_out} discussed above appears. Construction and operation of 3-level buck converters is known to those skilled in the art, and thus some details have been omitted for sake of brevity. For purposes of the discussion herein, 3-level buck converter 108 may be thought of as taking an input voltage (Vbus1/Vbus2) and producing a regulated output voltage V_{buck_out}.

Two-stage switched capacitor converter 109 is also implemented as having two symmetric trains, an upper train and a lower train, each of which receives the input voltage V_{buck_out}. These two trains can be operated in an interleaved fashion, meaning that one is operational while the other is idle and vice-versa. This can be useful, for example, to reduce voltage ripple appearing at the output (i.e., V_{DD_main}), to allow for switching devices and capacitors rated for lower operating currents, etc.

In the illustrated embodiment, each train includes two flying capacitor stages. For example, the upper train includes a first stage including flying capacitor Cfly2a (and optionally resonant inductor Lfly2a) along with associated switching devices SC2a, SC4a, and SC5a. The upper train also includes a second stage including flying capacitor Cfly3a (and optionally resonant inductor Lfly3a) along with associated switching devices SC3a, SC6a, and SC7a. Finally, the upper train also includes switch SC1a. Similarly, the lower train includes a first stage including flying capacitor Cfly2b (and optionally resonant inductor Lfly2b) along with associated switching devices SC2b, SC4b, and SC5b. The upper train also includes a second stage including flying capacitor Cfly3b (and optionally resonant inductor Lfly3b) along with associated switching devices SC3b, SC6b, and SC7b. Finally, the upper stage also includes switch SC1b.

In general, switched capacitor converters can operate as described in greater detail below to produce an output voltage that is an integer multiple or integer fraction of the input voltage. In a step-down configuration, as illustrated in FIG. 1C, the output voltage is an integer fraction of the input voltage, with the integer being one plus the number of operational flying capacitor stages. Thus, if both flying capacitor stages are in operation, a two-stage switched capacitor converter will have a fixed voltage conversion ratio of 3:1, meaning the output voltage of the switched capacitor converter is ⅓ the input voltage. If one flying capacitor stage is bypassed, it will have a fixed voltage conversion ratio of 2:1, meaning the output volage of the switched capacitor converter is ½ the input voltage. If both flying capacitor stages are bypassed, it will have a fixed voltage conversion ratio of 1:1. Further details of such an operation are described below. However, switched capacitor converter topologies are effectively bidirectional, thus by reversing the input and output, a two-stage switched capacitor converter can be operated to have a step-up (rather than step-down) voltage conversion ratio of 3:1, 2:1, or 1:1, although this alternative configuration is not discussed in detail herein.

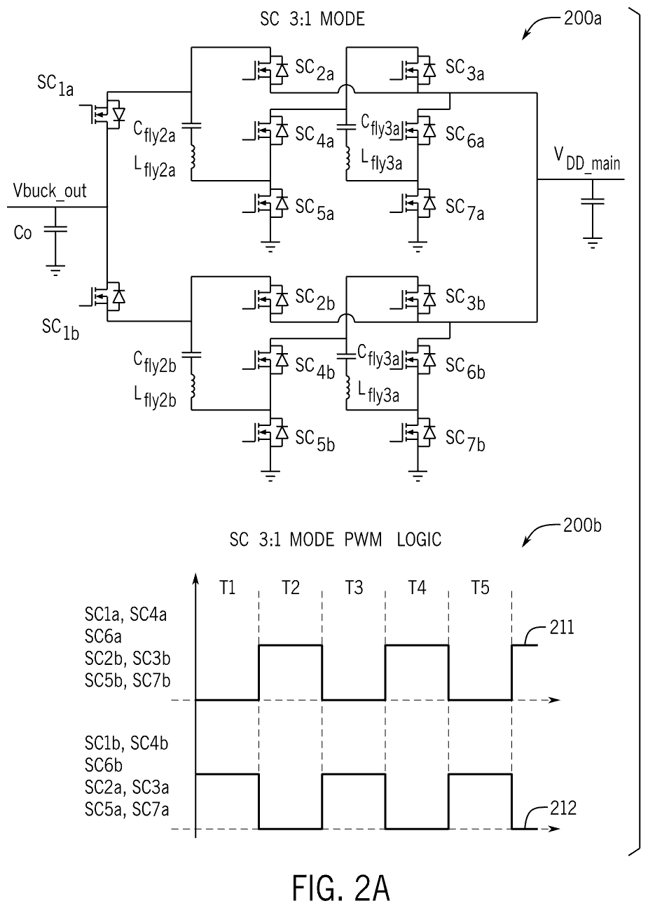

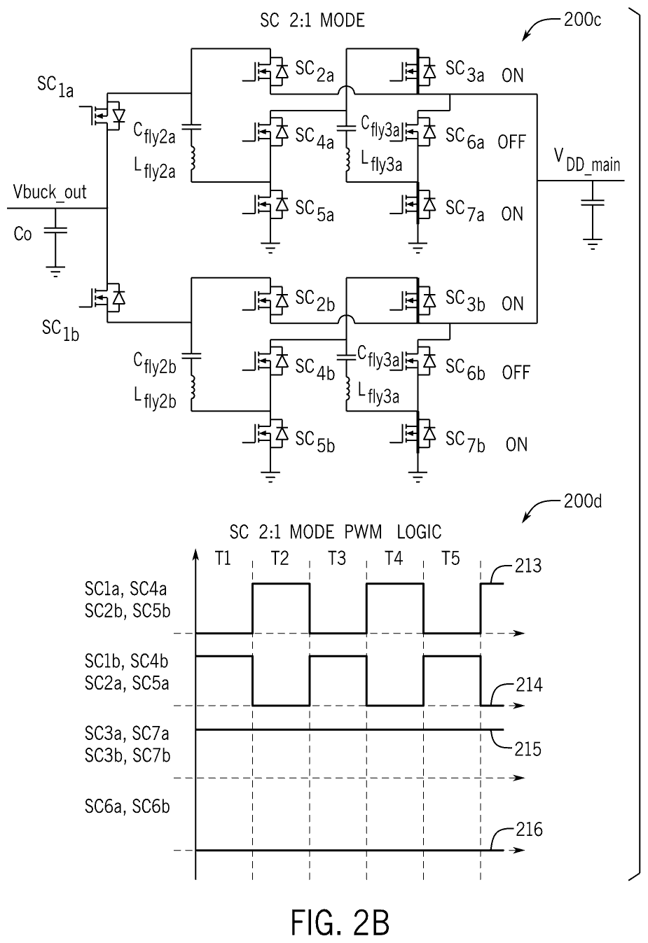

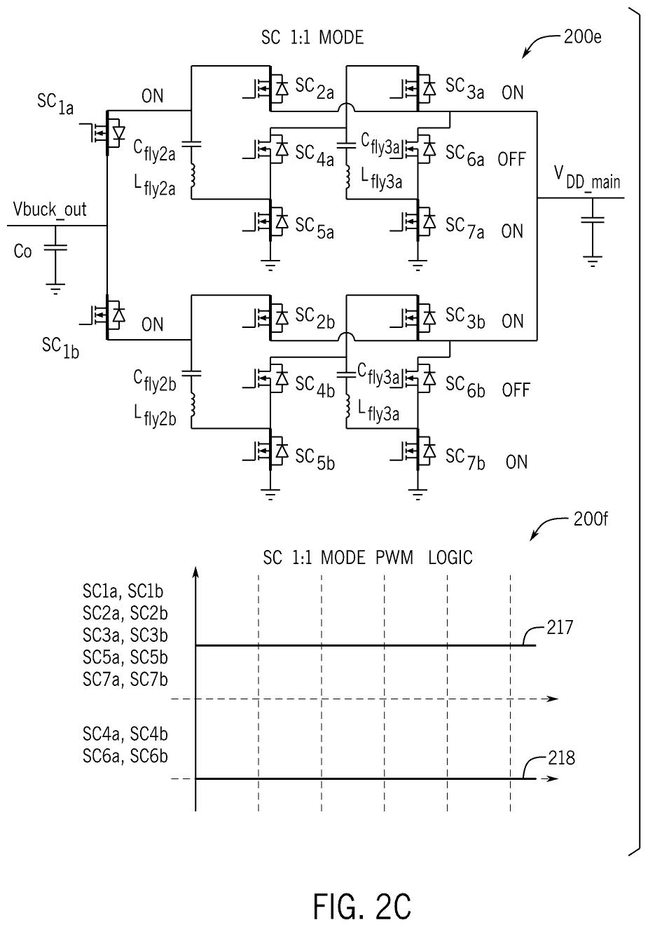

FIG. 2A illustrates a schematic of a switched capacitor converter 200a operating in a 3:1 conversion mode, along with associated switching logic depicted in plot 200b. To understand this operating mode, the upper train and lower train of switched capacitor converter 200a (which correspond to switched capacitor converter 109 described above) can be thought of as separate converters that operate in an interleaved fashion. Each train has a plurality of switching devices (identified above) that can be divided into two groups. When switches of the first group are being operated, switches of the second group are not being operated, and vice-versa. Additionally, when switches of the first group of the upper train are being operated, switches of the second group of the lower train are being operated, and vice-versa. For the upper train, the first group of switches can include switches SC1a, SC4a, and SC6a, and the second group of switches can include switches SC2a, SC3a, SC5a, and SC7a. For the lower train, the first group of switches can include switches SC1b, SC4b, and SC6b, and the second group of switches can include switches SC2b, SC3b, SC5b, and SC7b. In the 3:1 conversion mode, the input voltage V_{buck_out} is three times the output voltage V_{DD_main}, and both flying capacitor stages of each train are being used (i.e., not bypassed) as illustrated in plot 200a.

Plot 200b illustrates which switches are in operation during respective intervals as described above. More specifically, an upper curve 211 corresponds to the above-described first group of switches of the upper train (i.e., switches SC1a, SC4a, and SC6a) and the second group of switches of the lower train (i.e., switches SC2b, SC3b, SC5b, and SC7b). These switches are operable during time intervals T2 and T4, while being disabled during intervals T1, T3, and T5. Conversely, a lower curve 212 corresponds to the above-described first group of switches of the lower train (i.e., switches SC1b, SC4b, and SC6b) and the above-described second group of switches of the upper train (i.e., switches SC2a, SC3a, SC5a, SC7a). These switches are operable during time intervals T1, T3, and T5, while being disabled during intervals T2 and T4.

To summarize, this switching operation alternately connects the flying capacitors of each train in a series connection between input and output, thereby charging the flying capacitors to store energy therein, and in a parallel connection with the output, thereby discharging energy stored in the flying capacitors to the load. As described above, while the upper train flying capacitors are charging in series, the lower train flying capacitors can be discharging in parallel, and vice-versa. As mentioned above, this can have the effect of reducing ripple seen at the output (V_{DD_main}) as well as allowing use of devices with lower current ratings, which may have cost, size, efficiency, or other advantages.

FIG. 2B illustrates a schematic of a switched capacitor converter stage 200c operating in a 2:1 conversion mode and associated switching logic depicted in plot 200d. To understand this operating mode, the upper train and lower train of switched capacitor converter 200c (which correspond to switched capacitor converter 109 described above) can be thought of as separate converters that operate in an interleaved fashion. Each train has a plurality of switching devices (identified above) that can be divided into four groups. When switches of the first group are being operated, switches of the second group are not being operated, and vice-versa. Additionally, switches of the third group are always on, and switches of the fourth group are always off, to effectively bypass the second flying capacitor stage as described in greater detail below. As described above with respect to FIG. 2B, when switches of the first group of the upper train are being operated, switches of the second group of the lower train are being operated, and vice-versa. For the upper train, the first group of switches can include switches SC1a and SC4a, and the second group of switches can include switches SC2a and SC5a. For the lower train, the first group of switches can include switches SC1b and SC4b, and the second group of switches can include switches SC2b and SC5b. The third group of switches, which are always on to effectively bypass the second flying capacitor stage, can include switches SC3a and SC7a for the upper train and switches SC3b and SC7b for the lower train. The fourth group of switches, which are always off to effectively bypass the second flying capacitor stage, can include switches SC6a for the upper train and SC7b for the lower train. As can be seen in FIG. 2B, this configuration of the third and fourth switch groups effectively connects the second stage flying capacitors Cfly3a and Cfly3b (and optional associated resonant inductors Lfly3a and Lfly3b) in parallel with the output of the switched capacitor converter, which gives the converter a single operational flying capacitor stage resulting in a 2:1 voltage conversion ratio. In the 2:1 conversion mode, the input voltage V_{buck_out} is twice the output voltage V_{DD_main}, and only one flying capacitor stage of each train is being used (i.e., not bypassed) as illustrated in plot 200c.

Plot 200d illustrates which switches are in operation during respective intervals as described above. More specifically, an upper curve 213 corresponds to the above-described first group of switches of the upper train (i.e., switches SC1a, and SC4a) and the second group of switches of the lower train (i.e., switches SC2b and SC5b). These switches are operable during time intervals T2 and T4, while being disabled during intervals T1, T3, and T5. Conversely, an upper middle curve 214 corresponds to the above-described first group of switches of the lower train (i.e., switches SC1b and SC4b) and the above-described second group of switches of the upper train (i.e., switches SC2a and SC5a). These switches are operable during time intervals T1, T3, and T5, while being disabled during intervals T2 and T4. A lower middle curve 215 corresponds to the third group of switches (i.e., switches SC3a, SC7a, SC3b, and SC7b), which are turned on continuously in the 2:1 mode to effectively connect the second flying capacitor stages in parallel with the output. Finally, a lower curve 216 corresponds to the fourth group of switches (i.e., switches SC6a, SC6b), which are turned off continuously in the 2:1 mode to effectively connect the second flying capacitor stages in parallel with the output.

To summarize, this switching operation alternately connects the first flying capacitor stages of each train in a series connection between input and output, thereby charging the flying capacitors to store energy therein, and in a parallel connection with the output, thereby discharging energy stored in the flying capacitors to the load. As described above, while the upper train flying capacitor is charging in series, the lower train flying capacitor can be discharging in parallel, and vice-versa. As mentioned above, this can have the effect of reducing ripple seen at the output (V_{DD_main}) as well as allowing use of devices with lower current ratings, which may have cost, size, efficiency, or other advantages.

FIG. 2C illustrates a schematic of a switched capacitor converter stage 200e operating in a 1:1 conversion mode and associated switching logic depicted in plot 200f. To understand this operating mode, the upper train and lower train of switched capacitor converter 200e (which correspond to switched capacitor converter 109 described above) can be thought of as both being completely bypassed. Each train has a plurality of switching devices (identified above) that can be divided into two groups. Switches of the first group are always on, and switches of the second group are always off, to effectively bypass both flying capacitor stages of each train, as described in greater detail below. The first group of switches, which are always on to effectively bypass the first and second flying capacitor stages, can include switches SC1a, SC2a, SC3a, SC5a, and SC7a for the upper train and switches SC1b, SC2b, SC3b, SC5b, and SC7b for the lower train. The second group of switches, which are always off to effectively bypass the first and second flying capacitor stages, can include switches SC4a and SC6a for the upper train and SC4b and SC6b for the lower train. As can be seen in FIG. 2C, this configuration of the first and second switch groups effectively connects the flying capacitors and optional associated resonant inductors in parallel with the output of the switched capacitor converter, which gives the converter no operational flying capacitor stages resulting in a 1:1 voltage conversion ratio. In the 1:1 conversion mode, the output voltage V_{DD_main} is the same as the input voltage V_{buck_out}, and neither flying capacitor stage of either train is being used (i.e., not bypassed) as illustrated in plot 200c.

Plot 200f illustrates which switches are in operation during respective intervals as described above. More specifically, an upper curve 217 corresponds to the first group of switches (i.e., switches SC1a, SC2a, SC3a, SC5a, SC7a, SC1b, SC2b, SC3b, SC5b, and SC7b), which are turned on continuously in the 1:1 mode to effectively connect the flying capacitor stages in parallel with the output. Likewise, lower curve 218 corresponds to the second group of switches (i.e., switches SC4a, SC6a, SC4b, and SC6b, which are turned off continuously in the 1:1 mode to effectively connect the flying capacitor stages in parallel with the output. To summarize, this switching operation effectively bypasses all flying capacitor stages, resulting in a more or less direct connection of the input (V_{buck_out}) to the output (V_{DD_main}).

In some applications, it may be desirable for a converter system as described above to transition from one operating mode (voltage conversion ratio) to another. For example, if different input voltages are received, such as 5V, 9V, 15V, or 20V from a USB-PD type power supply, it may be more effective or more efficient for the switched capacitor converter to operate at a different voltage conversion ratio. However, because of the various capacitances in the circuit, e.g., the regulated converter output capacitor Co and the flying capacitors of the switched capacitor converter, these mode transitions can lead to large inrush currents as charge redistributes among the capacitors as a result of such mode transitions.

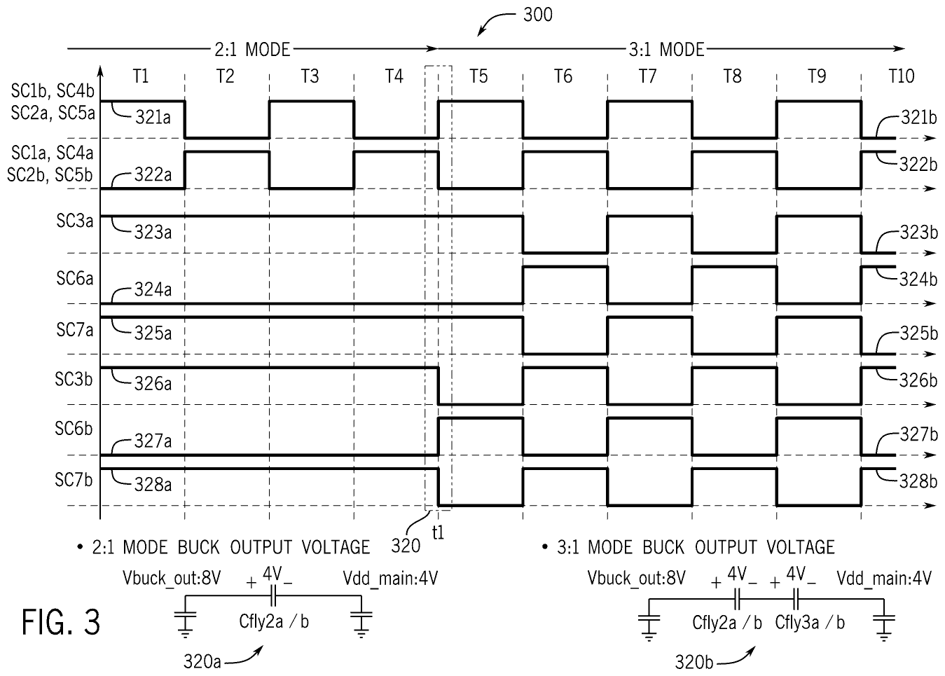

FIG. 3 illustrates a timing diagram 300 illustrating a switched capacitor converter as described above, executing a transition from a 2:1 operating mode to a 3:1 operating mode, as well as a depiction of inrush current causes for such a transition. The left side of timing diagram 300, including time intervals T1-T4, illustrate operation of various switch groups operating in the 2:1 mode described above with reference to FIG. 2B. The curves 321a-328a illustrate the operation of the identified switch groups in the 2:1 mode and correspond to plot 200d discussed above with reference to FIG. 2B. At the lower left portion of FIG. 3, a simplified schematic 320a shows an example operating situation in a 2:1 conversion mode, with the regulated converter producing an output voltage V_{buck_out} of 8V, a switched capacitor converter output voltage V_{DD_main} of 4V, and an average voltage of 4V across the flying capacitors Cfly2a/b. As described above with respect to FIG. 2B, the second stage flying capacitors Cfly3a/b are bypassed in this mode. These voltages are just one example, and any suitable operating voltages could be employed.

Transition interval 320 occurs at time t1, and the switched capacitor converter can switch from the 2:1 mode as described above with reference to FIG. 2B to the 3:1 mode as described above with reference to FIG. 2A. The right side of timing diagram 300, including time intervals T5-T10, illustrate operation of various switch groups operating in the 3:1 mode described above with reference to FIG. 2A. The curves 321b-328b illustrate operation of the identified switch groups in the 3:1 mode and correspond to plot 200b, discussed above with reference to FIG. 2A. At the lower right portion of FIG. 3, a simplified schematic 320b shows an example operating situation in a 3:1 conversion mode, with the regulated converter producing an output voltage V_{buck_out} of 12V, a switched capacitor converter output voltage V_{DD_main} of 4V, and an average voltage of 4V across each set of flying capacitors Cfly2a/b and Cfly3a/b. These voltages are just one example, and any suitable operating voltages could be employed.

If there is no inrush current mitigation employed during the transition from 2:1 to 3:1 mode, an in-rush current can be observed in the switched capacitor converter flying capacitors (Cfly2a/b, Cfly3a/b) and 3-level buck output capacitor Co caused by capacitor charge redistribution because the 3-level buck converter output voltage suddenly changes from 8V to 12V. In this case, the inrush current will be from the switched capacitor converter flying capacitors to the buck output capacitors. However, in other transitions, e.g., 3:1 to 2:1, the inrush current could flow in the other direction. Thus, it may be desirable to employ inrush current mitigations in the form of modified switching techniques during transition interval 320, examples of which are described in greater detail below.

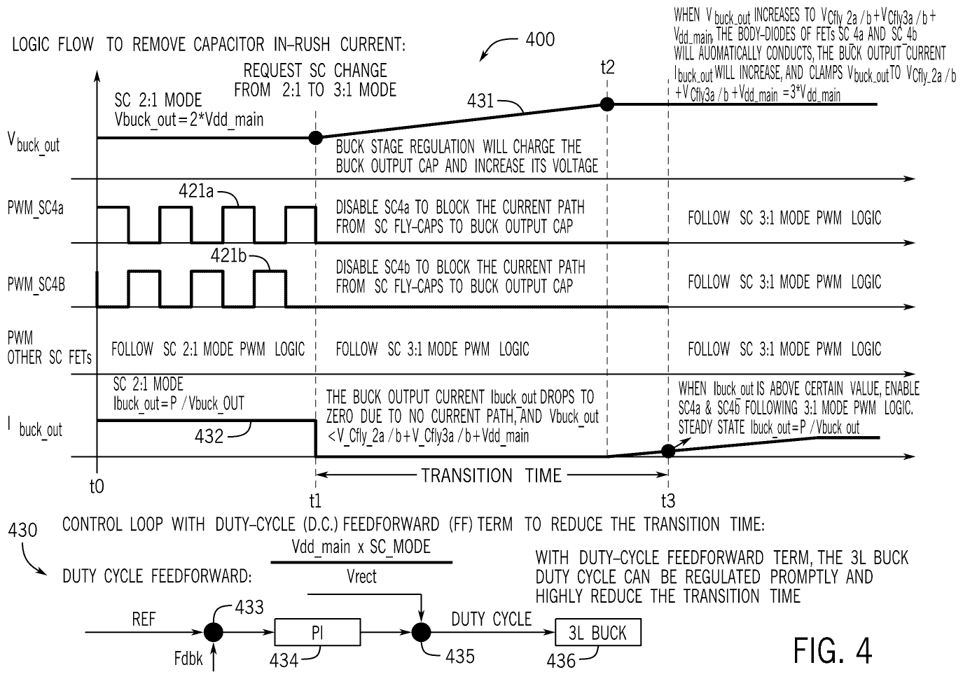

FIG. 4 illustrates a timing diagram 400 of a switching transition to mitigate inrush current associated with a 2:1 to 3:1 mode transition of a switched capacitor converter and an associated control loop 430. Timing diagram 400 includes a series of plots of switched capacitor converter input voltage (V_{buck_out}), switching of switches SC4a and SC4b, illustrated by curves 421a and 421b, switching of other switching devices, and switched capacitor converter input current I_{buck_out}, curve 432. These aspects are depicted for a first interval from time t0 to t1, corresponding to the 2:1 operation mode, a second interval from time t1 to t3, corresponding to the transition interval 320 identified above with reference to FIG. 3, and a third interval following time t3, corresponding to the 3:1 operating mode.

From time t0 to time t1, the switched capacitor converter can operate in a 2:1 conversion mode as was described above with respect to FIG. 2B. During this interval, the regulated converter (i.e., 3-level buck converter) can have a constant output voltage V_{buck_out} that is equal to twice the output voltage of the switched capacitor converter V_{DD_main}. Switches SC4a and SC4b can be selectively enabled and disabled as described above, illustrated by curves 421a and 421b, and all other switching devices of the switched capacitor converter can follow the above-described switching logic for the 2:1 operating mode. As indicated by curve 432, the input current to the switched capacitor converter, which is also the output current of the 3-level buck converter can be at a constant level I_{buck_out} corresponding to the operating power divided by the voltage V_{buck_out}.

At time t1, the request for the switched capacitor converter to change from the 2:1 operating mode to the 3:1 operating mode can occur. This can involve control circuitry 106, which can detect a change in operating conditions necessitating this transition. Thus, beginning at time t1, the regulated converter, e.g., 3-level buck converter 108 can change its voltage regulation target and begin increasing the voltage appearing at its output, i.e., across output capacitor Co. This is represented by the increase in curve 431, i.e., V_{buck_out}, over the transition interval beginning at time t1 and ending at time t2, prior to the end of the transition interval at time t3. When V_{buck_out} increases to V_{Cfly_2a/b}+V_{Cfly3a/b}+V_{dd_main}, the body-diodes of FETs SC_4a and SC_4b will automatically conduct, the buck output current I_{buck_out} will increase, and clamp V_{buck_out} to V_{Cfly_2a/b}+V_{Cfly3a/b}+V_{dd_main}=3*V_{dd_main}., as described in greater detail below.

Also beginning at time t1, control circuitry 106 can disable switching of switched capacitor converter switches SC4a and SC4b to block the current path from the switched capacitor flying capacitors to the 3-level buck converter output capacitors, mitigating the inrush current. At the end of the transition interval, i.e., at time t3, switching for these devices can be enabled according to the 3:1 mode logic described above with reference to FIG. 2A. All other switching devices, i.e., all devices other than switches SC4a/SC4b can transition to the 3:1 mode operating logic described above immediately at the beginning of the transition interval, i.e., at time t1.

Also during transition time t1 to t3, the output current of the regulated converter I_{buck_out}, which is also the input current into the switched capacitor converter, will initially drop to zero, as the current path is blocked by the disabling of switches SC4a/SC4b described above and because the buck converter output voltage V_{buck_out} is less than the sum of the voltages across the flying capacitors Cfly2a/b and Cfly3a/b and the output voltage V_{DD_main} of the switched capacitor converter. However, as noted above, at time t2, when V_{buck_out} increases to V_{Cfly_2a/b}+V_{Cfly3a/b}+V_{dd_main}, the body-diodes of FETs SC_4a and SC_4b will automatically conduct, the buck output current I_{buck_out} will increase, and clamp V_{buck_out} to V_{Cfly_2a/b}+V_{Cfly3a/b}+V_{dd_main}=3*V_{dd_main}. Once the current I_{buck_out} is above a selected threshold value, e.g., at time t3, switches SC4a and SC4b can be re-enabled according to the 3:1 operating mode described above, and the steady state value of I_{buck_out} will settle at the delivered power divided by the V_{buck_out} voltage.

In the lower portion of FIG. 4, a simplified control loop 430 for the 3-level buck converter is depicted. This control loop can be implemented by control circuitry 106 discussed above using any suitable combination of analog, digital, and/or programmable circuitry. Control loop 430 can implement a duty cycle feed forward for switching of the 3-level buck converter (or other type of regulated converter) to reduce the transition time. Control loop 430 can receive a voltage reference Ref corresponding to the desired output voltage V_{buck_out} and a feedback signal Fdbk corresponding to a measured value of this same voltage. These can be subtracted (by block 433) to generate an error signal that can be supplied to a proportional-integral controller 434 that can generate an output signal corresponding to a desired duty cycle of the switching devices of the three-level buck converter. This signal can be supplied as one input to a summing junction 435, which can also receive a feed-forward signal corresponding to the output voltage of the switched capacitor (V_{DD_main}) times the operating mode of the switched capacitor converter (e.g., 3, 2, 1, etc.) divided by the input voltage of the converter system Vrect (corresponding to Vbus1/Vbus2).

Summing junction 435 can add these two signals to produce the final duty cycle signal applied to 3-level buck converter 436. Thus, when the system transitions from a lower conversion ratio to a higher conversion ratio (i.e., 1:1 to 2:1, 2:1 to 3:1, etc.), the feed forward signal will cause a more rapid change in the required duty cycle than would be provided by PI controller 434 alone, allowing for improved transient response. Similarly, when the system transitions from a higher conversion ratio to a lower conversion ratio (i.e., 2:1 to 1:1, 3:1 to 2:1, etc.), the feed forward signal will likewise cause a more rapid change in the required duty cycle, allowing for improved transient response. Thus, with this duty-cycle feedforward term, the 3-level buck duty cycle can be regulated promptly, thereby highly reducing the transition time.

To summarize, reducing the inrush current associated with a 2:1 to 3:1 transition of a switched capacitor converter can include: (1) Turning off switches SC4a & SC4b after enabling the SC mode from 2:1 to 3:1, and turning them back on when (a) they have current flow through their body-diode or (b) there is positive current flowing from buck stage to the switched capacitor stage. (2) During the transition from 2:1 mode to 3:1 mode, if switches SC1a/4a/6a can be turned on at the same time operating with the 3:1 mode switching logic, fly-capacitors Cfly2a and Cfly3a will be connected in series with output voltage V_{DD_main}. Then switched capacitor converter input voltage V_{buck_out} will jump from V_{DD_main}+V_Cfly2a=2*V_{DD_main} (from operation in 2:1 mode) to V_{DD_main}+V_Cfly2a+V_Clfy3a=2*V_{DD_main}+V_Cfly2a=3*V_{DD_main} (from operation in 3:1 mode). As a result, an in-rush current can be observed from the fly-caps to buck output caps. (3) During the transition from 2:1 mode to 3:1 mode, if switches SC4a/4b are turned off, the in-rush current path from the flying capacitors to the buck output capacitor Co can be substantially reduced because it is blocked by switches SC4a/4b. The 3-level buck converter regulation loop can then increase the buck output capacitor (Co) voltage. Once its voltage reaches 3*V_{DD_main}, current will begin to flow through the body diodes of switches SC4a/4b body-diodes to the switched converter output (V_{DD_main}).

Additionally, for the 3-level buck converter control loop, a duty cycle feed forward term can be added to various closed-loop control modes, such as current mode control (average current mode, peak current mode, etc.) or voltage mode control. One benefit of a duty cycle feed forward term in the control loop can be to increase the 3-level buck converter output capacitor (Co) voltage (V_{buck_out}) more quickly during the switched capacitor converter mode transition from 2:1 to 3:1, thus reducing the mode transition time. If a duty cycle feed forward term is not added, the switched capacitor converter mode transition time from 2:1 to 3:1 may be longer, but the inrush current between the 3-level buck converter output capacitor (Co) and the switched capacitor converter flying capacitors can still be substantially reduced. Thus, the duty cycle feed forward modification of the control loop can be optional.

Although the above-described transition is described in the context of a 2:1 to 3:1 transition, the same control logic and strategy can be applied to a 1:1 to 2:1 mode transition. Thus, inrush current mitigations of any upward step in conversion ratio can be based on temporarily disabling switching devices SC4a and SC4b to block the inrush current path during the transition, including optionally providing feed forward duty cycle control of the regulated converter to shorten the transition time.

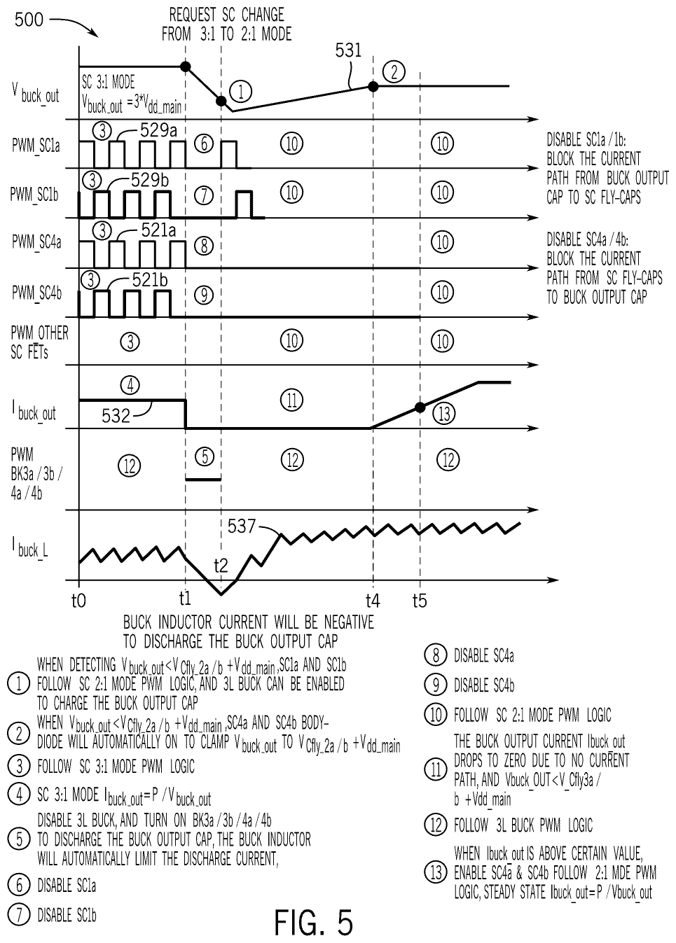

FIG. 5 illustrates a timing diagram 500 of a first switching transition to mitigate inrush current associated with a 3:1 to 2:1 mode transition of a switched capacitor converter. Timing diagram 500 illustrates a series of waveforms from a time t0, prior to the switched capacitor mode transition from a 3:1 mode to a 2:1 mode, through time t1, where the transition is initiated, until time t5, when the transition is completed. Intermediate times t2 and t4 during the transition also specify certain relevant timings. Beginning with waveform 531, the 3-level buck converter (or other regulated converter) output voltage V_{buck_out} is depicted. From time t0 until time t1, i.e., prior to the 3:1 to 2:1 mode transition, this voltage is at a level equal to three times the switched capacitor converter output voltage, i.e., V_{buck_out}=3*V_{DD_main}. At time t1, the mode transition is initiated, and the voltage decreases until time t2, discussed in greater detail below.

Plots 529a and 529b indicate the switching logic associated with switches SC1a and SC1b, respectively. Plots 521a and 521b indicate the switching logic associated with switches SC4a and SC4b. When the 3:1 to 2:1 mode transition is requested at time t1, all four of these switches are disabled until time t2. At time t2 switches SC1a and SC1b are reenabled with the 2:1 mode switching logic described above with reference to FIG. 2B, while switches SC4a and SC4b remain disabled until time t5, marking the end of the transition, at which point they begin operating according to the 2:1 mode switching logic described above with respect to FIG. 2B. Disabling switches SC4a and SC4b blocks the inrush current path from the switched capacitor converter flying capacitors to the 3-level buck converter (or other regulated converter) output capacitor in a manner similar to that described above with reference to FIG. 4 and the associated 2:1 to 3:1 mode transition. The t2 and t5 timing events are discussed in greater detail below. Below curve 521b, the switching logic for all other switched capacitor converter switching devices is depicted. Prior to t1, i.e., prior to initiation of the 3:1 to 2:1 mode transition, all switched capacitor switches other than those mentioned above operate according to the 3:1 switch logic described above with respect to FIG. 2A. After initiation of the transition at time t1, these switches all operate according to the 2:1 mode logic described above with respect to FIG. 2B.

Curve 532 illustrates the output current of the 3-level buck converter (or other regulated converter) I_{buck_out}. Prior to time t1, this current is equal to the power being delivered divided by the output voltage of the 3-level buck converter, i.e., I_{buck_out}=P/V_{buck_out}. At time t1, when the 3:1 to 2:1 transition is initiated, the current drops to zero because there is no longer an output current path, and V_{buck_out}<V_Cfly_2a/b+V_Cfly3a/b+V_{DD_main}. This current remains at zero until time t4, discussed in greater detail below.

Below curve 532, the switching logic for certain switches of the 3-level buck converter are depicted. Generally, the switches operate normally according to the 3-level buck converter (or other regulated converter) control loop for all intervals other than the interval between time t1, when the 3:1 to 2:1 switched capacitor converter mode transition is initiated, until time t2, discussed in greater detail below. During this interval, switching of certain switches of the regulated converter, e.g., 3-level buck switches other than BK3a/3b/4a/4b can be disabled, and switches BK3a/3b/4a/4b can be turned on to discharge output capacitor Co. During this mode, the buck inductor (L1a/L1b) can limit the discharge current. Finally, curve 537 depicts the current through the buck inductor(s) Ibuck_L, which will exhibit ripple associated with the switching operation during the interval prior to time t1. Then at time t1, the buck inductor current will decrease and become negative to discharge output capacitor Co as the system executes the 3:1 to 2:1 transition. Thereafter, the current will increase to a new higher level (assuming the same operating power at the new, lower regulated converter output voltage), again exhibiting the current ripple associated with the switching operation.

Returning to curve 531 at the top of timing diagram 500, after the 3:1 to 2:1 operating mode transition is initiated at time t1, the 3-level buck converter (or other regulated converter) output voltage V_{buck_out} will begin to decrease by virtue of the switched capacitor switch disabling described above with respect to switches SC1a/SC1b/SC4a/SC4b. Once the output voltage V_{buck_out} is less than V_{Cfly_2a/b}+V_{DD_main}, which occurs at time t2, switches SC1a and SC1b can be re-enabled following the 2:1 mode switching logic, as was described above with reference to curves 529a and 529b. Additionally, the 3-level buck converter can be re-enabled to charge the output capacitor Co, as discussed above with reference to curve 537. Thus, this time t2 will also correspond to the minimum (and negative) buck inductor current depicted in curve 537.

During the interval from time t2 to t4, operation of the circuit can continue as already described above. During this interval, the 3-level buck converter (or other regulated converter) output voltage V_{buck_out} can continue to increase until it reaches V_{Cfly_2a/b}+V_{DD_main}=2*V_{DD_main} at time t4, which is the steady state operating condition for the 2:1 mode. When V_{buck_out} reaches V_{Cfly_2a/b}+V_{DD_main} (at time t4), the body diodes of switches SC4a and SC4b will automatically turn on to clamp V_{buck_out} to V_{Cfly_2a/b}+V_{DD_main}. Otherwise, operation of the circuit can still further continue as described above until time t5, at which 3-level buck converter output current I_{buck_out} is above a predetermined threshold, at which point switches SC4a and SC4b can be re-enabled, operating according to the 2:1 mode logic described above with reference to FIG. 2B. At this time, the steady state regulated converter output current I_{buck_out} will be equal to the operating power (P) divided by the regulated converter output voltage V_{buck_out}, i.e., I_{buck_out}=P/V buck_out.

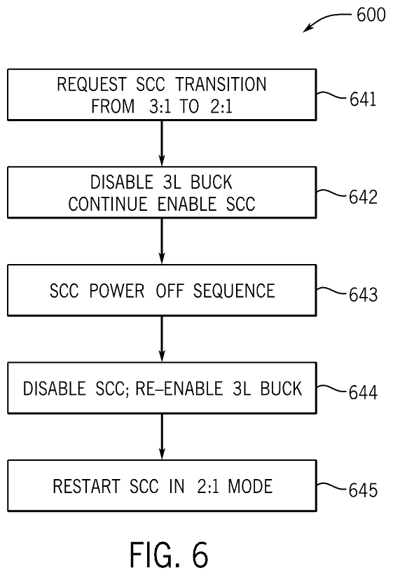

FIG. 6 illustrates a flow chart 600 of a second, alternative switching transition to mitigate inrush current associated with a 3:1 to 2:1 mode transition of a switched capacitor converter. Rather than selective disabling and re-enabling of certain switching devices during the transition time, as described above with respect to FIG. 5, the technique of FIG. 6 can instead temporarily disable the converters and re-enable them in the new operating mode. Thus, beginning at block 641, the switched capacitor converter can receive the request to initiate the transition from the 3:1 operating mode to the 2:1 operating mode (this corresponds to time t1 in FIG. 5, discussed above). Thereafter (block 642), the control circuitry can disable the 3-level buck converter (or other regulated converter) while the switched capacitor converter remains enabled. This can allow normal operation of the switched capacitor converter to discharge energy stored in 3-level buck converter output capacitor Co that is now excess because of the now lower needed operating voltage. Then, in block 643, the control circuitry can initiate a power off sequence of the switched capacitor converter, allowing the converter to shutdown, which can include controlled discharge of the flying capacitors and the buck output capacitor. Once the switched capacitor converter has been disabled (turned off) in block 644, the control circuitry can then restart 3-level buck converter (or other regulated converter). Finally, in block 645, the control circuitry can re-enable the switched capacitor converter, now operating in the 2:1 mode.

The techniques for reducing inrush current associated with a 3:1 to 2:1 mode transition described above with reference to FIGS. 5 and 6 can also be employed with respect to 2:1 to 1:1 mode transitions and/or 3:1 to 1:1 mode transitions. Additionally, although described in terms of a two-stage switched capacitor converter, which is capable of operating in 3:1, 2:1 or 1:1 operating modes, the techniques described herein can be extended to single stage converters, which have only 2:1 or 1:1 operating modes, or switched capacitor converters with higher numbers of stages, i.e., n-stage converters capable of operating in a n+1, . . . , 2:1, or 1:1 operating modes. With respect to the step-up mode transitions as described in FIG. 4 and the step-down mode transitions as described in FIG. 5, blocking the inrush current can be achieved by temporarily disabling switching of certain switches (e.g., switches SC4a/4b and their analogues in higher order converters) to block the inrush current path during the portion of the transition where such inrush current could occur. With respect to the step-down mode transition technique of FIG. 6, blocking the inrush current can be achieved by temporarily disabling the 3-level buck converter (or other regulator converter) while allowing continued operation of the switched capacitor converter to continue operation discharging output capacitor Co. Then, the switched capacitor converter can be disabled, followed by reenabling of the 3-level buck converter and re-enabling of the switched capacitor converter in the new operating mode. The mode transition technique in FIG. 6 can also apply to the step-up mode transition.

The foregoing describes exemplary embodiments of switched capacitor converter mode transitions to mitigate inrush current. Such configurations may be used in a variety of applications but may be particularly advantageous when used in conjunction with power supplies for personal electronic devices, such as smart phones, tablet computers, notebook computers, and associated accessories, such as earphones, styluses, or other peripheral devices. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A power supply system comprising:
a regulated converter that receives an input voltage and produces a regulated output voltage;
a switched capacitor converter comprising one or more flying capacitors and a plurality of associated switching devices that receives the regulated output voltage of the regulated converter and multiplies it by a selectable conversion ratio; and
control circuitry that operates the regulated converter and the switched capacitor converter to change the selectable conversion ratio while limiting inrush current flowing between the one or more flying capacitors of the switched capacitor converter and an output capacitor of the regulated converter.

2. The power supply system of claim 1 wherein the regulated converter comprises a 3-level buck converter.

3. The power supply system of claim 2 wherein the regulated converter comprises two 3-level buck converters operated in an interleaved fashion.

4. The power supply system of claim 1 wherein the switched capacitor converter comprises two switched capacitor stages and is capable of operating with a 3:1 conversion ratio, a 2:1 conversion ratio, and a 1:1 conversion ratio, wherein the control circuitry operates the switched capacitor converter according to first switching logic to achieve the 3:1 conversion ratio, according to second switching logic to achieve the 2:1 conversion ratio, and according to third switching logic to achieve the 1:1 conversion ratio.

5. The power supply system of claim 4 wherein the switched capacitor converter comprises two 3-level buck converters operated in an interleaved fashion.

6. The power supply system of claim 1 wherein the control circuitry operates the regulated converter and the switched capacitor converter to change the selectable conversion ratio from a first conversion ratio to a second conversion ratio higher than the first conversion ratio while limiting inrush current flowing between the one or more flying capacitors of the switched capacitor converter and an output capacitor of the regulated converter by temporarily disabling one or more of the plurality of switches of the flying capacitor converter to block an inrush current path during a transition time.

7. The power supply system of claim 6 wherein:
the transition time during which one or more of the plurality of switches of the flying capacitor converter are disabled begins when a conversion ratio change request is received and ends after the regulated voltage of the regulated converter increases to a new voltage corresponding to a new conversion ratio and body diodes of the temporarily disabled switching devices begin conducting current; and
the transition time during which one or more of the plurality of switches of the flying capacitor converter are disabled ends after an output current of the regulated converter increases to a threshold value.

8. The power supply system of claim 6 wherein the control circuitry provides a duty cycle feed forward term associated with the regulated converter to reduce the transition time.

9. The power supply system of claim 1 wherein the control circuitry operates the regulated converter and the switched capacitor converter to change the selectable conversion ratio from a first conversion ratio to a second conversion ratio lower than the first conversion ratio while limiting inrush current flowing between the one or more flying capacitors of the switched capacitor converter and an output capacitor of the regulated converter by temporarily disabling one or more of the plurality of switches of the flying capacitor converter to block an inrush current path during a transition time.

10. The power supply system of claim 9 wherein:
the transition time during which a first group of one or more switches is disabled begins when a conversion ratio change request is received and ends after the regulated voltage of the regulated converter decreases to a voltage below a new voltage corresponding to a new conversion ratio as a result of negative current flowing through an inductor of the regulated converter; and
the transition time during which a second group of one or more switches is disabled begins when the conversion ratio change request is received and ends after the regulated voltage of the regulated converter increases to a new voltage corresponding to the new conversion ratio.

11. The power supply system of claim 10 wherein the transition time during which the second group of one or more switches is disabled ends after an output current of the regulated converter increases to a threshold value.

12. The power supply system of claim 1 wherein the control circuitry operates the regulated converter and the switched capacitor converter to change the selectable conversion ratio from a first conversion ratio to a second conversion ratio while limiting inrush current flowing between the one or more flying capacitors of the switched capacitor converter and an output capacitor of the regulated converter by:
disabling the regulated converter;
initiating a power off sequence of the switched capacitor converter;
disabling the switched capacitor converter;
re-enabling the regulated converter; and
re-enabling the switched capacitor converter with the second conversion ratio.

13. A method of operating a power supply system comprising a regulated converter that receives an input voltage and produces a regulated output voltage and a switched capacitor converter including one or more flying capacitors and a plurality of associated switching devices that receives the regulated output voltage of the regulated converter and multiplies it by a selectable conversion ratio, the method being performed by control circuitry of the power supply system and comprising:
changing the selectable conversion ratio; and
limiting inrush current flowing between the one or more flying capacitors of the switched capacitor converter and an output capacitor of the regulated converter.

14. The method of claim 13 wherein:
changing the selectable conversion ratio comprises changing the selectable conversion ratio from a first conversion ratio to a second conversion ratio higher than the first conversion ratio; and
limiting inrush current flowing between the one or more flying capacitors of the switched capacitor converter and an output capacitor of the regulated converter further comprises temporarily disabling one or more of the plurality of switches of the flying capacitor converter to block an inrush current path during a transition time.

15. The method of claim 14 wherein:
the transition time during which one or more of the plurality of switches of the flying capacitor converter are disabled begins when a conversion ratio change request is received and ends after the regulated voltage of the regulated converter increases to a new voltage corresponding to a new conversion ratio and body diodes of the temporarily disabled switching devices begin conducting current; and
the transition time during which one or more of the plurality of switches of the flying capacitor converter are disabled ends after an output current of the regulated converter increases to a threshold value.

16. The method of claim 13 further comprising providing a duty cycle feed forward term associated with the regulated converter to reduce the transition time.

17. The method of claim 13 wherein:
changing the selectable conversion ratio comprises changing the selectable conversion ratio from a first conversion ratio to a second conversion ratio lower than the first conversion ratio; and
limiting inrush current flowing between the one or more flying capacitors of the switched capacitor converter and an output capacitor of the regulated converter comprises temporarily disabling one or more of the plurality of switches of the flying capacitor converter to block an inrush current path during a transition time.

18. The method of claim 17 wherein:
the transition time during which a first group of one or more switches is disabled begins when a conversion ratio change request is received and ends after the regulated voltage of the regulated converter decreases to a voltage below a new voltage corresponding to a new conversion ratio as a result of negative current flowing through an inductor of the regulated converter; and
the transition time during which a second group of one or more switches is disabled begins when the conversion ratio change request is received and ends after the regulated voltage of the regulated converter increases to a new voltage corresponding to the new conversion ratio.

19. The method of claim 18 wherein the transition time during which the second group of one or more switches is disabled ends after an output current of the regulated converter increases to a threshold value.

20. The method of claim 13 wherein:
changing the selectable conversion ratio comprises changing the selectable conversion ratio from a first conversion ratio to a second conversion ratio; and
limiting inrush current flowing between the one or more flying capacitors of the switched capacitor converter and an output capacitor of the regulated converter further comprises:
disabling the regulated converter;
initiating a power off sequence of the switched capacitor converter;
disabling the switched capacitor converter;
re-enabling the regulated converter; and
re-enabling the switched capacitor converter with the second conversion ratio.
